(19) United States
(12) Patent Application Publication
(10) Pub. No.: US 2012/0212380 A1
(43) Pub. Date: Aug. 23, 2012

(54) PLANAR ANTENNA DEVICE AND STRUCTURE

(75) Inventors: David M. THEOBOLD, Pittsboro, NC (US); David Arthur BLUM, Boston, MA (US); Gregory T. SCHULTE, Minneapolis, MN (US); Alan GRESZLER, Westlake, OH (US); Vincent OWENS, Hingham, MA (US)

(73) Assignee: PNEUMOSONICS, INC., Cleveland, OH (US)

(21) Appl. No.: 13/401,055

(22) Filed: Feb. 21, 2012

Related U.S. Application Data
(60) Provisional application No. 61/569,069, filed on Dec. 9, 2011.
(60) Provisional application No. 61/566,844, filed on Dec. 5, 2011.
(60) Provisional application No. 61/445,230, filed on Feb. 22, 2011.

(51) Int. Cl. H01Q 1/38; H01Q 1/00

(52) U.S. Cl. 343/720; 343/700 MS

(57) ABSTRACT

The invention may provide an antenna device including a communication interface to couple the antenna device to an external device and a package housing with an adhesive surface. A planar antenna pattern may be fabricated on a substrate within the package housing, wherein the antenna pattern is configured to transmit an ultra-wideband signal and to receive a reflection of the transmitted signal.

### RELATED APPLICATIONS

This application claims priority to provisional U.S. Patent Application Ser. No. 61/445,230 filed on Feb. 22, 2011, the content of which is incorporated herein in its entirety; this application claims priority to provisional U.S. Patent Application Ser. No. 61/566,844 filed on Dec. 5, 2011, the content of which is incorporated herein in its entirety; and this application claims priority to provisional U.S. Patent Application Ser. No. 61/569,069 filed on Dec. 9, 2011.

This application also incorporates by reference the contents of U.S. application Ser. No. 12/713,616, filed on Feb. 26, 2010.

### BACKGROUND

The present invention relates to antenna devices for monitoring medical conditions using micropower impulse radar (MIR) technology.

Medical conditions often present themselves as a change in body composition. For example, a pneumothorax is a medical condition where a pocket of air is trapped in the pleural space around the lungs, making breathing difficult. In some cases, pneumothorax can lead to a collapse of a lung and possibly even death. It is most often caused by blunt trauma to the chest, such as the trauma experienced in some car accidents.

A pneumothorax can also be caused by errors in medical procedures such as central line placement. Typically, after a central line placement, the patient receives a precautionary x-ray or ultrasound to detect for a possible pneumothorax. For example, the portable x-ray must be brought in and the patient relocated to acquire an image. Ultrasound imaging systems, although portable and bedside, require a coupling gel to interface the hand-held probe with the patients body. However, pneumothorax diagnosis by x-rays or ultrasounds is cumbersome. Also, a skilled professional (i.e., a doctor) must usually interpret the x-ray or ultrasound images for pneumothorax diagnosis. Moreover, x-rays or ultrasounds are not suitable for continuous monitoring of a pneumothorax during or after a medical procedure.

Thus, there is a need in the art for an easy to use non-invasive medical condition monitoring system.

### BRIEF DESCRIPTION OF THE DRAWINGS

FIG. 1 is a simplified block diagram a medical condition monitoring system according to an embodiment of the present invention.

FIGS. 2(a)-(c) illustrate an antenna device according to an embodiment of the present invention.

FIGS. 3(a)-(b) illustrate an antenna device with a rigid substrate according to an embodiment of the present invention.

FIGS. 4(a)-(b) illustrate an antenna device with a flexible substrate according to an embodiment of the present invention.

FIG. 5 illustrates an antenna device configuration according to an embodiment of the present invention.

FIGS. 6(a)-(b) illustrate exemplary reflectivity patterns according to an embodiment of the present invention.

FIG. 7 is a simplified block diagram a medical condition monitoring system according to an embodiment of the present invention.

FIG. 8 is a simplified block diagram an antenna device according to an embodiment of the present invention.

FIG. 9 is a simplified block diagram an antenna device according to an embodiment of the present invention.

FIG. 10 is a simplified block diagram a medical condition monitoring system according to an embodiment of the present invention.

### DETAILED DESCRIPTION

Embodiments of the present invention may provide an antenna device including a communication interface to couple the antenna device to an external device and a package housing with an adhesive surface. A planar antenna pattern may be fabricated on a substrate within the package housing, wherein the antenna pattern is configured to transmit an ultra-wideband signal and to receive a reflection of the transmitted signal.

The antenna device may be used in a non-invasive medical condition monitoring system in patients utilizing MIR technology. The medical condition can be a medical disorder, dysfunction or other abnormality. The patients can be humans or other mammalian subjects. An exemplary system includes a detector and the antenna device. The detector may perform a scan by generating one or more MIR pulses that are transmitted into the patient through the antenna device, which may be affixed to a specified location on the patient. Reflections or echoes of the pulses from various bodies within the patient (e.g., muscle, tissue, fluid) may be captured by the antenna device. Electrical signals generated by the antenna device or devices may be interpreted by a processor to detect the presence, location, extent, and volume of a medical disorder, dysfunction or other abnormality.

According to embodiments of the present invention, the antenna device may be modular (i.e., connectable to the detector device). After an initial reference scan, the antenna device may be disconnected readily from the detector device while remaining affixed to the patient's body. The antenna device may be reconnected later to the detector device for subsequent target scan(s). The antenna device may be manufactured with relatively inexpensive components. In medical work environments where maintaining sterile conditions is paramount, a low-cost disposable antenna device may be advantageous. Therefore, the antenna device may be provided as a “single use” disposable device. Single use may refer to a complete procedure use on a single subject including an initial reference scan and any subsequent target scan(s).

The systems of the present invention may be used to detect or monitor various medical conditions including confirming whether medical treatment results in a therapeutic benefit. Exemplary monitoring and diagnostic uses of the systems of the present invention include detecting and monitoring pneumothoraces (including iatrogenic and traumatic pneumothoraces), hematomas, perforated bowels, fluid pooling in and around tissues such as pericardial effusion and pleural effusion, stomach content changes or distention, changes in bone growth, respiratory function during anesthesia delivery, tumor progression, hemorrhages or aneurysms, and onset of kidney or gallstones.

The systems may also be incorporated with other systems and devices to provide integrated diagnostic or monitoring systems. Exemplary devices include implantable or insertable medical devices, including intravascular devices. A non-limiting example of an implantable device includes an electrical stimulation device and a non-limiting example of an intravascular device includes a catheter. The systems of the present invention may also be integrated with medical intervention monitoring systems.

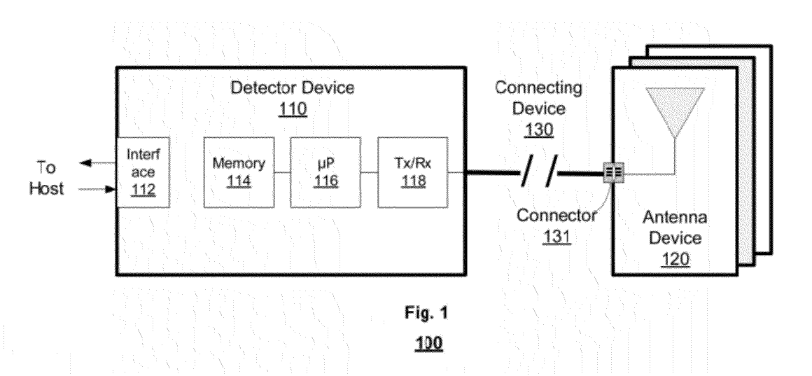

FIG. 1 is a simplified block diagram of a medical condition monitoring system 100 in which embodiments of the present invention may be provided. The system 100 may include a detector device 110, a connecting device 130, and an antenna device 120. The detector device 110 may be coupled to the antenna device 120 through a connecting device 130 via a connector 131.

The detector device 110 may include an interface 112, a memory 114, a processor 116, and transceiver (Tx/Rx) circuitry 118. The interface 112 may couple the detector device 110 to a remote host system such as a laptop, notebook, tablet computer, desktop computer or the like. In an embodiment, the interface 112 may be a USB port. In another embodiment, the interface 112 may facilitate wireless communication with the host system such as by long range communication (e.g., cellular), short range communication (e.g., WIFI, Bluetooth) or a combination thereof.

The memory 114 may be provided as a volatile memory, a non-volatile memory, or a combination thereof. The memory 114 may store program instructions for the processor 116, scan data generated by the system 100 and any pattern data (discussed below) as needed by the system 100.

The processor 116 may be a microcontroller or a microprocessor. The processor 116 may execute the instructions stored in the memory 116 and may control the operations of the detector device 110.

The Tx/Rx circuitry 118 may generate MIR pulse(s) and send the pulse(s) to the antenna device 120 to be transmitted as electromagnetic waves into the patient's body. The Tx/Rx circuitry 118 may also receive corresponding reflections of the transmitted electromagnetic waves captured by the antenna device 120. The components and operations of the Tx/Rx circuitry 118 may be provided as described in U.S. patent application Ser. No. 12/713,616 filed on Feb. 26, 2010 (published as US 2010/0222663), which is incorporated herein in its entirety.

The connecting device 130 may couple the detector device 110 to the antenna device 120 via the connector 131. In an embodiment, the connecting device 130 may be provided as a coaxial cable. In another embodiment, the connecting device 130 may be provided as a wireless communication network such as WIFI, Bluetooth or the like.

Responsive to MIR pulse(s) generated by the detector device 110, the antenna device 120 may transmit electromagnetic waves corresponding to the MIR pulse(s). The antenna device 110 may also capture corresponding reflections of the transmitted electromagnetic waves from the patient's body. The antenna device 120 may be detachable from the detector device 110. The antenna device 120 may be provided as an ultra-wideband (UWB) planar antenna. Embodiments of the antenna device 120 are described below in further detail.

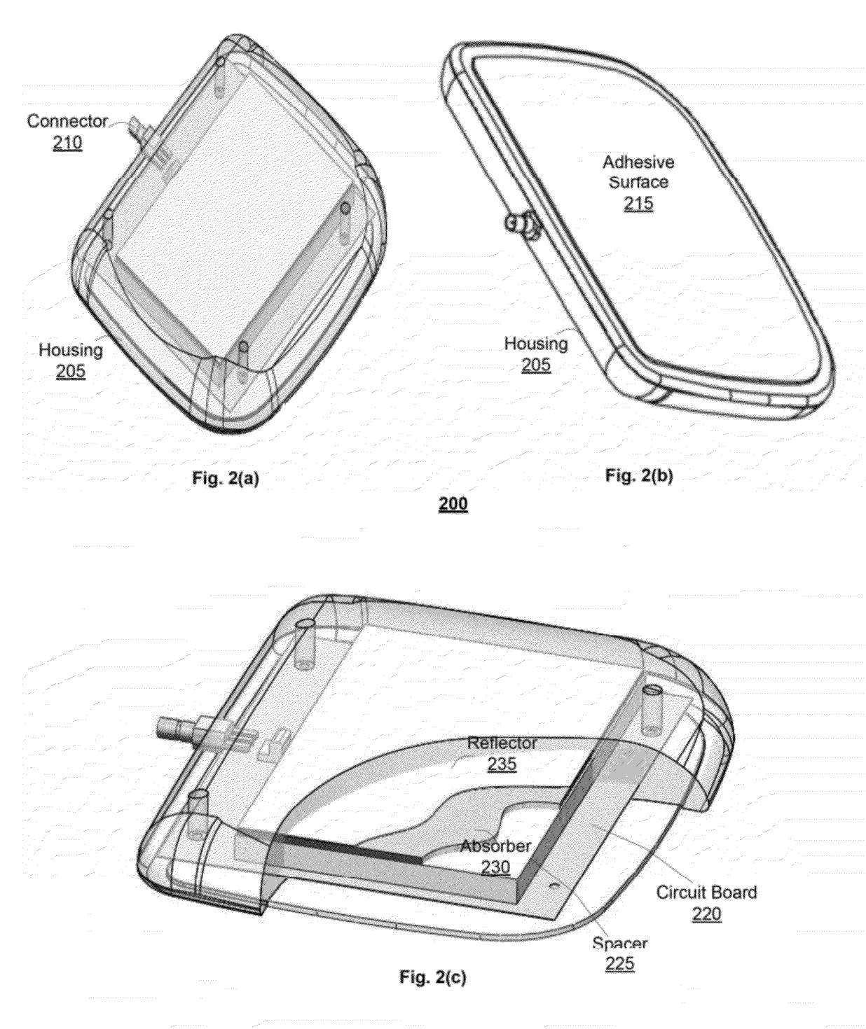

FIGS. 2(a)-(c) illustrate an antenna device 200 according to an embodiment of the present invention. FIG. 2(a) is a perspective view showing an upper surface of the antenna device 200, FIG. 2(b) is a perspective view showing a lower surface of the antenna device 200, and FIG. 2(c) is a cutaway view of the antenna device 200. The antenna device 200 may include a housing 205, a connector 210, an adhesive surface 215, a circuit board 220 (a substrate), a spacer 225, an absorber 230, and a reflector 235. The antenna device 200 may also include other components described herein that are not shown in FIG. 2.

The housing 205 may be a package housing that encapsulates the other components of the antenna device 200 to provide a protective cover as well as provide matching impedance for antenna radiation. In an embodiment, the housing 205 may be provided as a plastic cover. The housing 205 may include upper and lower housing portions in which components of the antenna device 200 may be enclosed. Alternatively, the housing 205 may provided as mold formed around the components of the antenna device 200. The housing 205 may include other packaging elements, cloth covers, adhesives, connectors, etc., to attach the antenna device 200 on a patient and to connect the antenna device to the detector device (FIG. 1). For example, the adhesive surface 215 may be provided on the lower surface of the housing 205. The adhesive surface 215 may provide a coupling surface that is attached to the patient. In an embodiment, the adhesive surface 215 may include a self adhesive electrode glue to mount the antenna device 200 to the patient's body. Utilizing the adhesive surface 215, the antenna device 200 may be left on the patient for a period of time when the detector device is detached from the antenna device 200 and then reattached at a later time.

In an embodiment the antenna device 200 may include a shorting mechanism (not shown) to disable its function, such a fusible link or other similar device, to prevent unauthorized reuse. In an embodiment, the antenna device may include a read only memory (ROM) (not shown) that stores data describing the antenna. For example, the antenna memory may store data representing the antenna's manufacturer, model number and serial number, which may be read out by a detector device as necessary to perform diagnostic operations.

The circuit board 220 may provide mechanical support for electrical components within the antenna device 200 (i.e., a substrate). Components may be mounted on the circuit board 260 (e.g., resistors) and/or may also be printed on the circuit board (e.g., antenna pattern) as desired. The circuit board 220 may include two major opposing surfaces. An antenna pattern may be fabricated on a first major surface of the circuit board 220 facing the adhesive surface 215. On the second major surface, which opposes the first major surface, of the circuit board 220, the spacer 225, the absorber 230, and the reflector 235 may be mounted.

The spacer 225 may provide physical separation between the circuit board 260 and other components (e.g., absorber 230). The spacer 225 may provide impedance isolation between the antenna pattern on the other side of the circuit board 220 and other components. The absorber 230 may provide absorption of undesired radiation from one side of a bidirectional radiating antenna pattern. In an embodiment, the absorber 230 may comprise resistively loaded polymer, ferrite loaded polymer, multilayer resistive sheets, frequency selective surfaces, tuned cavity materials, and other like material. The reflector 235 may be provided as a conductive shield. The spacer 225, absorber 230, and/or the reflector 235 may contribute to reducing unwanted back-radiation from the antenna pattern as described below.

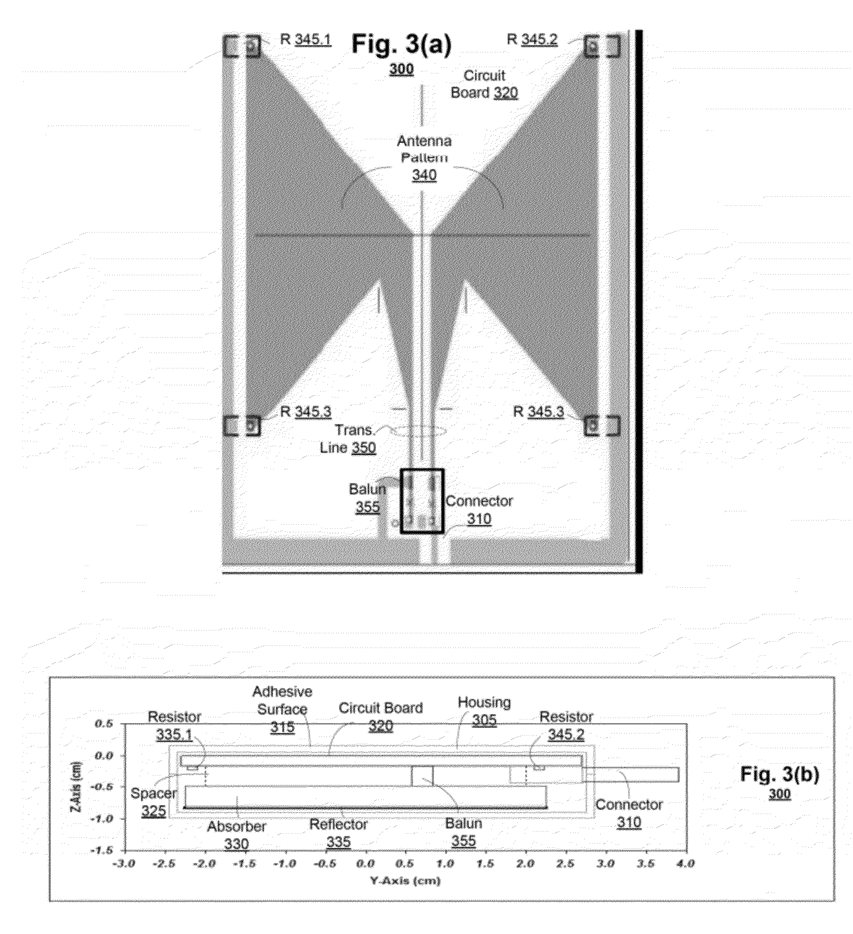

Antenna device embodiments of the present invention may be provided with a rigid circuit board or a flexible circuit board. FIGS. 3(a) and 3(b) illustrate an antenna device 300 with a rigid circuit board according to an embodiment of the present invention. FIG. 3(a) is a simplified circuit board diagram of the antenna device 300, and FIG. 3(b) is a simplified cross-sectional diagram of the antenna device 300.

The antenna device 300 may include a housing 305 with an adhesive surface 315 on one side, a connector 310, a circuit board 320, a spacer 325, an absorber 330, a reflector 335, an antenna pattern 340, resistors 345.1-345.4, a set of transmission lines 350, and a balun circuit 355.

The housing 305 with the adhesive surface 315 on one side may be provided as described above in the FIG. 2 discussion of the antenna device 200 and its respective components. The description will not be repeated here.

The connector 310 may provide a connection from the antenna device 300 to a coupled detector device (FIG. 1) as well as provide an impedance match between the two devices. The connector 310 may be coupled to the balun circuit 355 and to the terminating resistors 345.1-345.4. In an embodiment, the connector 350 may be provided as three conducting pads with one pad connecting to the balun circuit 355 and two pads connecting to the terminating resistors 345.1-345.4. The connector 310 may provide mechanical support for connection to a variety of different cables, such as a SubMiniature version A (SMA), Small SubMiniature version B (SSMB), MicroMinature Coaxial (MMC) or the like. Specific mechanical configurations are not illustrated in FIG. 3.

The circuit board 320 may be provided as a rigid circuit board such as a glass PCB, a FR4 or the like. The circuit board 320 may have two major opposing surfaces. The spacer 325, the absorber 330, and the reflector 335 may be mounted on one major surface of the circuit board 320. The spacer 325, the absorber 330, and the reflector 335 may be provided as described above in the FIG. 2 discussion of the antenna device 200 in FIG. 2 and its respective components. The description will not be repeated here.

The antenna pattern 340 may be fabricated on the opposing major surface of the circuit board 320 as the spacer 325, the absorber 330, and the reflector 335 (i.e., the surface facing the adhesive surface 315). The antenna pattern 340 may be provided as an ultra-wideband radiating element, and the antenna pattern 340 may be a bidirectional radiator. The antenna pattern 340 in FIG. 3(a) is shown as a bow tie format. In an embodiment, the antenna pattern 340 may be provided with a Sierpinski sieve pattern (not shown in FIG. 3(a)). The Sierpinski sieve pattern, for example, may advantageously reduce the size of the antenna device size 300 while maintaining the desired operating wavelength of the device and lowering the resonance frequency. The antenna pattern 340 may also be provided as another wideband radiator such as a meanderline, fractal path, spiral, or other suitable folded conductive format. The antenna pattern 340 may provide linear polarization; however, the antenna pattern 340 may also provide simultaneous or switched cross-polarization, or circularly polarization.

The typical frequency range of operation may be 100 MHz through 2000 MHz, and resonance may typically occur near 500 MHz. The wide bandwidth may help to preserve the edge features of target reflections from dielectric discontinuities within the body. The wide bandwidth may be several times the resonance frequency of the antenna, and the width of the bowtie may be tuned to the desired resonance frequency. The bowtie width may be geometrically set based on the package housing 205's symmetry, topology and material.

The terminating resistors 345.1-345.4 may be provided at the corners of the antenna pattern 340 and may minimize unwanted reflections from the antenna pattern 340. The transmission line 350 may conduct electromagnetic energy between and the antenna pattern 340 and other electrical components. The transmission line 350 may also balance impedance between the antenna pattern 340 and other electrical components. The balun circuit 355 may provide a balanced-to-unbalanced match as well as an impedance match between the antenna pattern 340 (via the transmission line 350) and the connector 310. The balun circuits 355 may be provided as a balun transformer. In FIG. 3(a), the transmission line 350 may be provided as a tapered transmission line as transformer to match the characteristic impedance of the bowtie element to the impedance of 1:1 balun circuit 355 (typically 50 ohms). The antenna device 300 may be relatively compact (e.g., less than 7 cm×8 cm) with a low profile (e.g., approximately 1 cm). Therefore, the antenna device 300 may be adhered to and left on the patient's body such as his/her chest for an extended period of time with relatively minor inconvenience to the patient. In an embodiment, the detector device and the connecting device (e.g., cable) may be disconnected from the antenna device while the antenna device remains adhered to the patient. The detector device may then be reconnected to the antenna device for subsequent target scans.

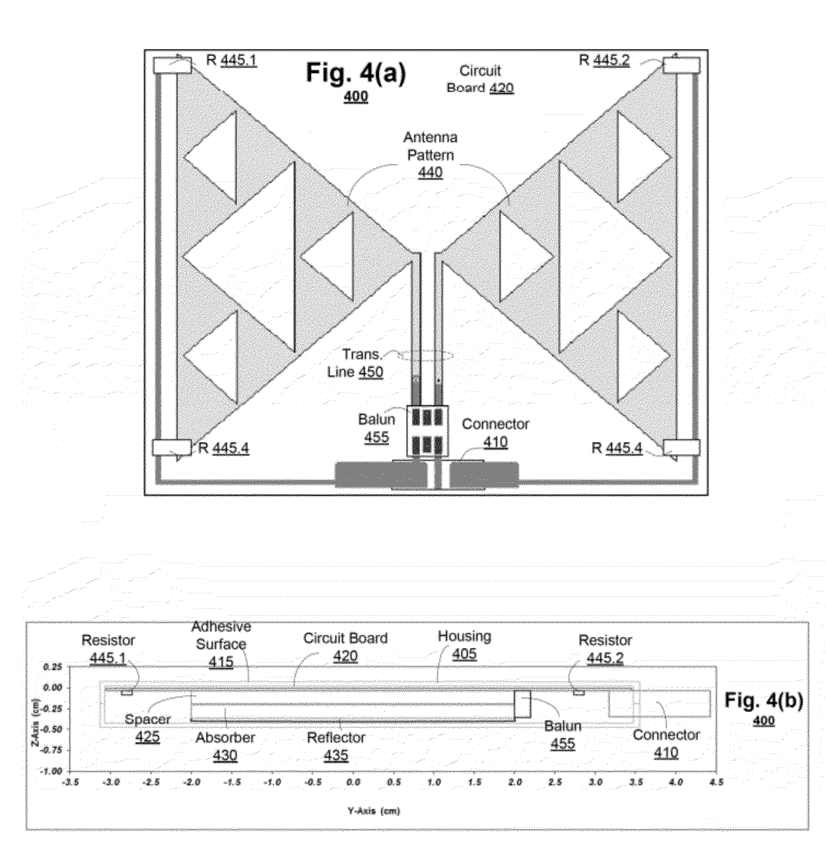

FIGS. 4(a) and 4(b) illustrate an antenna device 400 with a flexible circuit board according to an embodiment of the present invention. FIG. 4(a) is a simplified circuit board diagram of the antenna device 400, and FIG. 4(b) is a simplified cross-sectional diagram of the antenna device 400. The flexible circuit board may be malleable to conform better to the patient's body for improved connection.

The antenna device 400 may include a housing 405 with an adhesive surface 415 on one side, a connector 410, a circuit board 420, a spacer 425, an absorber 430, a reflector 435, an antenna pattern 440, resistors 445.1-445.4, a set of transmission lines 450, and a balun circuit 445.

The housing 405 with the adhesive surface 415 on one side may be provided as described above in the FIG. 2 discussion of the antenna device 200 and its respective components. The description will not be repeated here.

The connector 410 may provide a connection from the antenna device 400 to a coupled detector device (FIG. 1) as well as provide an impedance match between the two devices. The connector 410 may be coupled to the balun circuit 455 and to the terminating resistors 445.1-445.4. In an embodiment, the connector 450 may be provided as three conducting pads with one pad connecting to the balun circuit 455 and two pads connecting to the terminating resistors 445.1-445.4. The connector 410 may provide mechanical support for connection to a variety of different cables, such as a SubMiniature version A (SMA), Small SubMiniature version B (SSMB), MicroMinature Coaxial (MMC) or the like. Specific mechanical configurations are not illustrated in FIG. 4.

The circuit board 420 may be provided as a flexible circuit board. The circuit board 420 may have two major opposing surfaces. The spacer 425, the absorber 430, and the reflector 435 may be mounted on one major surface of the circuit board 320. The spacer 425, the absorber 430, and the reflector 435 may be provided as described above in the FIG. 2 discussion of the antenna device 200 and its respective components. The description will not be repeated here.

The antenna pattern 440 may be fabricated on the opposing major surface (i.e., the surface facing the adhesive surface 415) 420 as the spacer 425, the absorber 430, and the reflector 435. The antenna pattern 440 may be provided as an ultra-wideband radiating element, and the antenna pattern 440 may be a bidirectional radiator. The antenna pattern 440 in FIG. 4(a) is shown as a bow tie format with a Sierpinski sieve pattern. The Sierpinski sieve pattern, for example, may advantageously reduce the size of the antenna device size 400 while maintaining the desired operating wavelength of the device and lowering the resonance frequency. The antenna pattern 440 may also be provided as another wideband radiator such as a meanderline, fractal path, spiral, or other suitable folded conductive format. The antenna pattern 440 may provide linear polarization; however, the antenna pattern 440 may also provide simultaneous or switched cross-polarization, or circularly polarization.

The typical frequency range of operation may be 100 MHz through 2000 MHz, and resonance may typically occur near 500 MHz. The wide bandwidth may help to preserve the edge features of target reflections from dielectric discontinuities within the body. The wide bandwidth may be several times the resonance frequency of the antenna, and the width of the bowtie may be tuned to the desired resonance frequency. The bowtie width may be geometrically set based on the package housing 205's symmetry, topology and material. For the Sierpinski sieve pattern, the resonance may be lowered by approximately 20%.

The terminating resistors 445.1-445.4 may be provided at the corners of the antenna pattern 440 and may minimize unwanted reflections from the antenna pattern 440. The transmission line 450 may conduct electromagnetic energy between and the antenna pattern 440 and other electrical components. The transmission line 450 may also balance impedance between the antenna pattern 440 and other electrical components. The balun circuit 455 may provide a balanced-to-unbalanced match as well as an impedance match between the antenna pattern 440 (via the transmission line 450) and the connector 410. The balun circuits 455 may be provided as a balun transformer. In FIG. 4(a), the transmission line 450 may be provided as a parallel transmission line whose impedance is matched along its entire length to the characteristic impedance of the bowtie connects to the balun circuit 455 that matches 50 ohms via a winding ratio 1:4.

The antenna device 400 may be relatively compact (e.g., less than 7 cm×8 cm) with a low profile (e.g., approximately 1 cm). Therefore, the antenna device 400 may be adhered to and left on the patient's body such as his/her chest for an extended period of time with relatively minor inconvenience to the patient. In an embodiment, the detector device and the connecting device (e.g., cable) may be disconnected from the antenna device while the antenna device remains adhered to the patient. The detector device may then be reconnected to the antenna device for subsequent target scans.

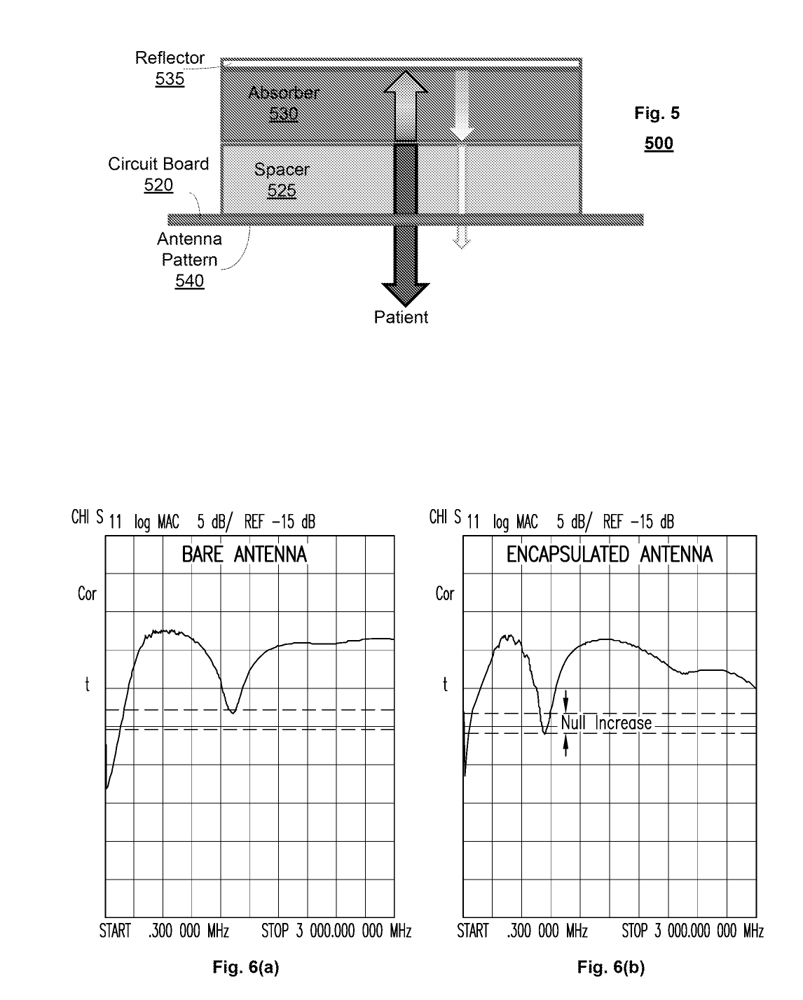

FIG. 5 illustrates an antenna device 500 component configuration that may block unwanted back radiation. The antenna device 500 may include a circuit board 520 with an antenna pattern 540, a spacer 525, an absorber 530, and a reflector 535. The circuit board 520 may be a rigid or flexible circuit board as described herein. The antenna pattern 540 may be fabricated on the circuit 520 and may be provided with any pattern described herein. The spacer 525, the absorber 530, and the reflector 535 may be mounted on the side of the circuit board 520 opposed to the antenna pattern 540. The spacer 525, the absorber 530, and the reflector 535 may be provided as described above in the FIG. 2 discussion of the antenna device 200 and its respective components. The description will not be repeated here.

The antenna pattern 540, which may be fabricated on the circuit board 520, may generate radiation in the form electromagnetic waves in both directions perpendicular to the circuit board 520. The back radiation, which are the electromagnetic waves transmitted away from the patient when the device is mounted, may propagate through the spacer 525 and then the absorber 530, which may absorb a significant amount of the back radiation. Any residual back radiation may then be reflected back by the reflector 535 into the absorber 530, where the reflected residual back radiation may once again be absorbed. Thus, reflector 535 may force a two-way trip of the back radiation through the absorber 530 thereby significantly reducing the back radiation (i.e., unwanted radiation) and any associated damaging effects such as interference with other electronics (e.g., the detector device) or the generation of multiple reflection in the MIR received signal.

In addition to providing a protective cover for the antenna device, the housing (e.g., housing 205, 305, 405 in FIGS. 2, 3, 4 respectively) may also improve antenna functionality. FIGS. 6(a) and 6(b) illustrate frequency distribution test reflectivity patterns of a bare antenna and an encapsulated antenna respectively. Water was used as the reflection medium since the human body is mostly composed of water and other fluids. As seen in the figures, the encapsulated antenna may provide resonance null improvement in the antenna's reflectivity pattern. The plastic may provide a better match to water than a bare circuit board resulting in the null improvement. It is expected that the impedance of the antenna and that of the water medium (i.e., a human body) may differ significantly, and the encapsulant may provide an intermediate dielectric medium to provide more efficient power transfer from the antenna to the water medium. Hence, the encapsulant may function as an impedance transformer between two different dielectric constant components.

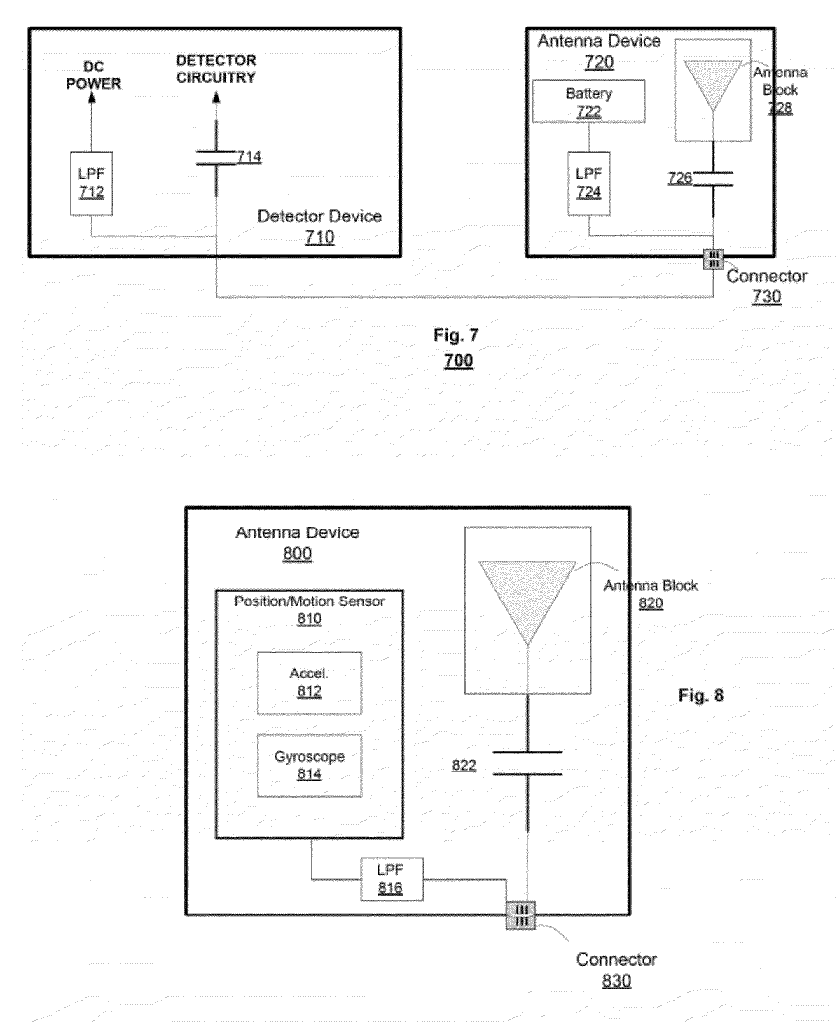

In an embodiment, a battery may be provided in the antenna device. For example, the battery may provide power for the antenna device and additionally to the coupled detector device. FIG. 7 illustrates a medical condition monitoring system 700 with an antenna power battery according to an embodiment of the present invention. The system 700 may include a detector device 710, an antenna device 720, and a connector 730. The detector device 710 may be coupled to the antenna device 720 via the connector 730.

The antenna device 720 may include a battery 722, a low pass filter (LPF) 724, a filtering capacitor 726, and an antenna block 728. The antenna block 728 may include an antenna pattern and associated RF circuitry as described herein. The incoming and outgoing RF signal from the antenna block 728 may be high pass filtered through filtering capacitor 726. In an embodiment, the battery 722 may be soldered on the antenna circuit board of the antenna block 728. Additional surface mount technology (SMT) components may also be provided on the antenna circuit board to support the battery 722.

DC power from the battery 722 may be multiplexed via LPF 724 onto the connector 730. The connector 730 may be provided as described herein, for example a coaxial connector. The multiplexed DC power may be de-multiplexed in the detector device 710 by the LPF 712. The filtered DC power from the LPF 712 may then supply power to the detector circuitry. RF signals also from the connector 720 may be received by the detector device 720 and may be high pass filtered through filtering capacitor 714 for processing by the detector circuitry.

In this embodiment, the detector device's 710 operations (turn on/off) may be in accordance with its connection state to the antenna device 720 because the detector device 720 may not include a separate power supply. Thus, in a connected state, the detector device 710 may power up when it receives DC power from the battery 722 in the antenna device 720. Otherwise, in a disconnected state, the detector device 720 may remain powered down.

In an embodiment, a medical condition monitoring system may include position and/or motion detection, which may be used to guide the placement of an antenna device of the system on the patient's body. The position/motion detection may be provided separately or may be integrated into the medical condition monitoring system. For example, the position/motion detection may be integrated into the antenna device.

FIG. 8 illustrates a simplified block diagram of an antenna device 800 with integrated position/motion sensing according to an embodiment of the present invention. The antenna device 800 may include a position/motion sensor 810, a LPF 816, an antenna block 820, a filtering capacitor 822, and a connector 830. The antenna block 820 may include an antenna pattern and associated RF circuitry as described herein. The incoming and outgoing RF signal from the antenna block 820 may be high pass filtered through filtering capacitor 822.

The position/motion sensor 810, in an embodiment, may include an accelerometer 812 and a gyroscope 814. For example, the position/motion sensor 810 may be provided as a six-axis (gyro yaw/pitch/roll plus accelerometer X/Y/Z) sensor. In an embodiment, the position/motion sensor 810 may be provided as a MEMS motion sensor including a package processing unit, for example the MPU-6000 by InvenSense™. The position/motion sensor 810 may be coupled to the connector 830 thru the LPF 816 to isolate the RF signals to and from the antenna block 820.

The position/motion sensor 810 may improve the precision and accuracy of the antenna device 800 placement on the patient. For example, the antenna device 800 may be moved to a desired detection point on the patient based on position/motion data from the position/motion sensor 810. The position/motion data may be processed by the coupled detector device and may provide moving instructions. The instructions may be provided in form of a reconstructed 3-D map based on the position/motion data.

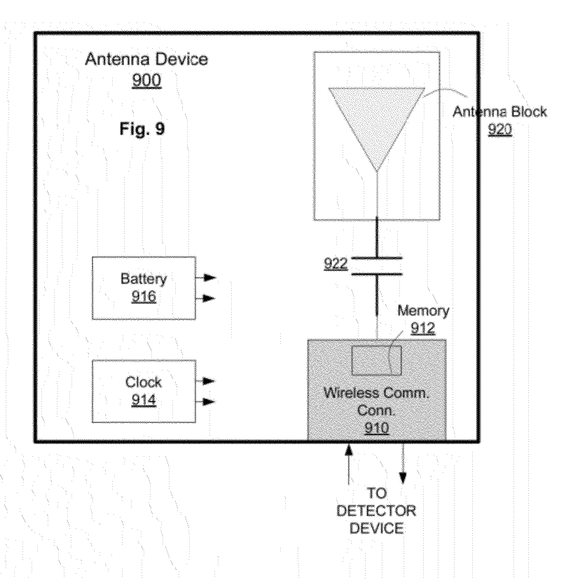

FIG. 9 illustrates a simplified block diagram of an antenna device 900 with an integrated wireless communication connector according to an embodiment of the present invention. The antenna device 900 may include a wireless communication connector 910, a clock 914, a battery 916, an antenna block 920, and a filtering capacitor 922. The antenna block 920 may include an antenna pattern and associated RF circuitry as described herein. The incoming and outgoing RF signal from the antenna block 920 may be high pass filtered through filtering capacitor 922.

The wireless communication connector 910 may include transmitting and receiving circuitry to implement wireless communication such as WIFI, Bluetooth, or the like. In an embodiment, the wireless communication connector 910 may include a memory 910.1, a processor 116, and Tx/Rx circuitry 118. The memory 910.1 may be provided as a volatile memory, a non-volatile memory, or a combination thereof. The processor 910.2 may be a microcontroller or a microprocessor. The Tx/Rx circuitry 910.3 may include a transceiver and digitizer to digitize the reflection data and a corresponding wireless communication modulator. Furthermore, the memory 910.1 may buffer data for transmission and store the received instructions from the wirelessly connected detector device.

The clock 914 may provide timing signals for various components in the antenna device 900, and the battery 916 may provide power to various components in the antenna device 900.

In an embodiment, multiple antenna device readings from multiple positions on the patient may improve a medical condition monitoring or imaging system. The multiple readings may provide information to reconstruct an image (e.g., 1-D depth, 2-D location, 3-D volumetric image) of the monitored medical condition such as a pneumothorax. A single antenna device may be used to perform multiple readings, which may require implicit information describing the locations at which each reading is taken.

Alternatively, an antenna array may be used to perform multiple readings. In an embodiment, an antenna array may increase the effective depth (or gain) relative to that of a single antenna. In another embodiment, an antenna array may increase the effective coverage area and concomitant location resolution relative to that of a single antenna.

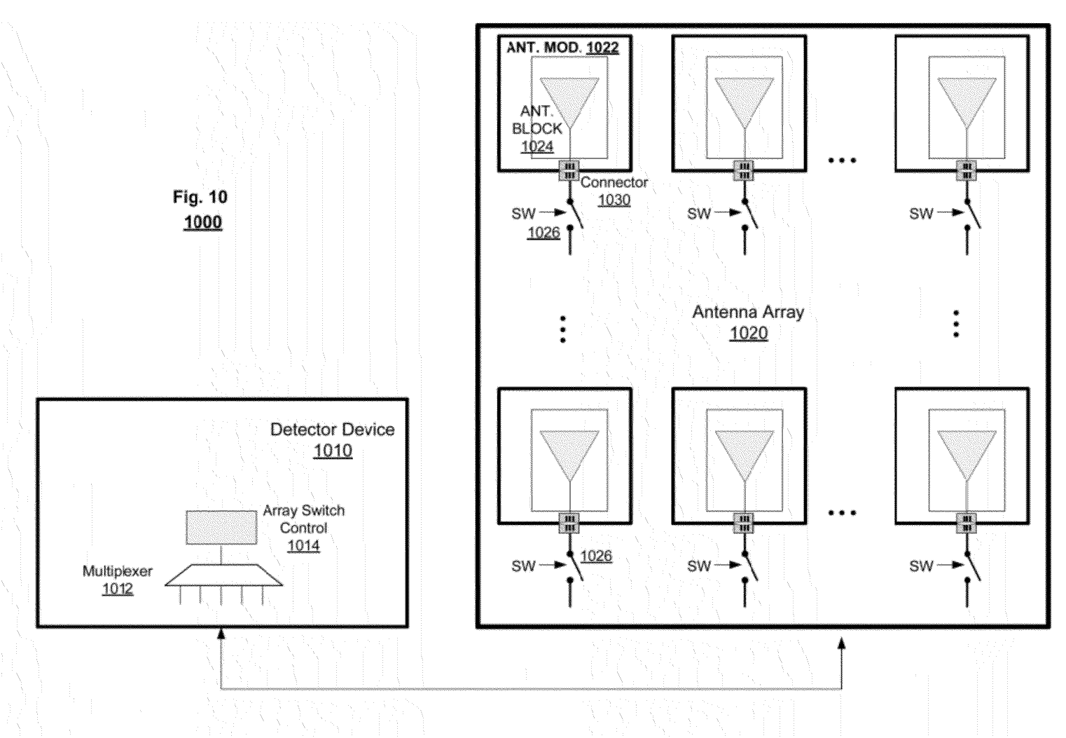

FIG. 10 illustrates a medical condition monitoring system 1000 with an antenna array according to an embodiment of the present invention. The system 1000 may include a detector device 1010 and an antenna array 1020. The detector device 1010 may include a multiplexer 1012, an array switch control 1014, and other operating circuitry described herein. The antenna array 1020 may include a plurality of antenna modules 1022 each including an antenna block 1024. The antenna block 1024 may include an antenna pattern and associated RF circuitry as described herein. The antenna modules 1022 may be coupled to the detector device with a connector 1030.

The detector device 1010 may be coupled to the individual antenna modules 1022 via respective switches 1026. For example, switches 1026 may be provided as switched transmission lines, and the switches may be controlled by the array switch control 1014. The transmission lines may be defined in such a manner that equivalent time delays are experienced as the transmitted and received pulses traverse the total transmission length. Alternatively, the transmission lines may be of arbitrary length, and a calibration procedure may be performed to adjust for differing transmission times between antenna modules. Thus, data acquisition delays may be compensated for each scan performed using different antenna modules of the arrays.

In an embodiment, the antenna modules 1022 may be connect to the detector device 1010 sequentially (i.e., one at a time), with each antenna module 1022 being used in one or more scans when connected. Each antenna module 1022 may be used as both the transmitting and receiving antenna element (mono-static MIR) or pairs of antenna modules 1022 may be used with one as the transmitting antenna and the other as the receiving antenna (bi-static MIR), depending upon the configuration of the array switch control 1014. The readings from the antenna modules (or from a single antenna) may be taken at predefined intervals where the intervals correspond in terms of distance gridded across a region of interest. The region of interest may be defined in a form of convenient topology, such as a hexagonal or Cartesian grid. Each individual reading may include information relating to characteristics of the monitored medical condition. For example, time and amplitude information of the readings may correspond to location and size of a monitored pneumothorax. Appropriate mathematical inversion techniques may be employed to reconstruct a graphical image (e.g., 2D or 3D) of the medical condition's shape, location, and volume.

Those skilled in the art may appreciate from the foregoing description that the present invention may be implemented in a variety of forms, and that the various embodiments may be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

We claim:

1. An antenna device, comprising:
a communication interface to couple the antenna device to an external device;
a package housing with an adhesive surface; and
a planar antenna pattern fabricated on a substrate within the package housing, wherein the antenna pattern is configured to transmit an ultra-wideband signal and to receive a reflection of the transmitted signal.

2. The antenna device of claim 1, wherein the substrate is rigid.

3. The antenna device of claim 1, wherein the substrate is flexible.

4. The antenna device of claim 1, wherein the antenna pattern is a folded conductive pattern.

5. The antenna device of claim 4, wherein the antenna pattern includes a Sierpinski sieve pattern.

6. The antenna device of claim 1 further comprises resistors mounted at the corners of the antenna pattern.

7. The antenna device of claim 1 further comprises a balun transformer mounted on the circuit board.

8. The antenna device of claim 1, wherein the communication interface is a mechanical connector.

9. The antenna device of claim 1, wherein the communication interface is a wireless communicator.

10. The antenna device of claim 1 further comprises a radiation blocking component on the substrate and an opposing side of the antenna pattern.

11. The antenna device of claim 10, wherein the radiation blocking component includes an absorber and a reflector.

12. The antenna device of claim 1, wherein the package housing provides a closer impedance match to a transmission medium than air.

13. The antenna device of claim 1 further comprises a power source located within the housing.

14. The antenna device of claim 1 further comprises a motion sensor.

15. The antenna device of claim 14, wherein the motion sensor includes an accelerometer and a gyroscope.

16. A method of operating an antenna device, comprising:
receiving an input signal corresponding to a microwave impulse radar pulse from an external device;
generating an ultra-wideband radiation signal based on the input signal via a planar antenna provided within a housing, wherein the radiation signal traverses through a transmission medium;
capturing a reflection of the radiation signal from an object in the transmission medium via the planar antenna; and
transmitting the reflection to the external device.

17. The method of claim 16 further comprises blocking the radiation signal in a direction opposite the transmission medium.

18. The method of claim 16, wherein the antenna device is powered internally.

19. The method of claim 16 further comprises sensing a position of the antenna device.

20. An antenna device, comprising:
a housing with an adhesive surface; and
an antenna array provided in the housing, each antenna element in the antenna array including a planar antenna pattern for transmitting and receiving ultra-wideband signals.

21. The antenna device of claim 20, further comprises a plurality of switches to control the operations of the antenna elements.

22. The antenna device of claim 21, wherein the plurality of switches operate the antenna elements in a mono-static mode.

23. The antenna device of claim 21, wherein the plurality of switches operate the antenna elements in a bi-static mode.

24. An antenna device, comprising:
a mechanical connector to readily connect and disconnect the antenna device from an external detector;
a plastic package housing with an adhesive surface to affix the antenna device on a subject;
a substrate within the plastic package housing, the substrate having two major opposing surfaces;
a planar antenna pattern printed on a first major surface of the substrate, the antenna pattern configured to transmit a bi-directional, ultra-wideband signal into the subject in response to a received microwave impulse radar pulse signal from the external detector and to receive corresponding reflections of the transmitted signal from various bodies within the subject, wherein the antenna pattern is a folded conductive pattern; and
a radiation blocking system mounted on a second major surface of the substrate.

25. The antenna device of claim 24, wherein the substrate is a rigid circuit board.

26. The antenna device of claim 24, wherein the substrate is a flexible circuit board.

27. The antenna device of claim 24, wherein the antenna pattern includes a Sierpinski sieve pattern.
